(19) United States
(12) Patent Application Publication
(10) Pub. No.: US 2026/0328395 A1
(43) Pub. Date: Oct. 22, 2026

(54) OPERATING SYSTEM OF A GAS COOKING APPLIANCE

(71) Applicant: BSH Hausgeräte GmbH, Munich (DE)

(72) Inventors: Roberto Carballo Fernandez, Santander (Cantabria) (ES); Alvaro Martinez Diez, Peñacastillo (Santander) (ES)

(21) Appl. No.: 19/113,980

(22) PCT Filed: Oct. 5, 2023
(86) PCT No.: PCT/EP2023/077511

§ 371 Date: Mar. 21, 2025

(30) Foreign Application Priority Data
Oct. 14, 2022 (EP) 22382987

(51) Int. Cl. F24C 3/12

(52) U.S. Cl. CPC F24C 3/124; F24C 3/126

(57) ABSTRACT

A control operating system of a gas cooking appliance includes a control panel having an opening for letting through a control shaft of a gas tap arranged behind the control panel. An operating element made in one piece includes a connecting part which includes a shaft designed to be press-fitted in a detachable manner on the control shaft of the gas tap to be actuated, and an actuating part including a front area and a skirt extending from the front area towards the control panel around the shaft. The control operating system includes a cap and a connecting system which is arranged between the cap and the operating element in such a manner that the cap is fixedly connectable to the operating element, thereby entirely covering the operating element, so that the control shaft of the gas tap is actuated when the cap is actuated.

The invention relates to a control operating system of a gas cooking appliance having a control panel with at least an opening for letting through a control shaft of a gas tap arranged behind the control panel, and an operating element made in one piece having a connecting part with a shaft that can be press-fitted in a detachable manner on the control shaft of the gas tap to be actuated and an actuating part with a front area and a skirt extending from the front area towards the control panel around the shaft.

Control operating systems of gas cooking appliances are known in which the operating element is made in one piece of injected plastic being connectable to the control shaft of the gas tap to control the gas tap and which can be demounted and replaced for a second operating element of the control operating system. Both operating elements need to be designed in compliance with the safety rules in force.

The object of the invention consists in particular in providing a simplified and more economical control operating system. According to the invention, this object is achieved by means of the features of claim 1, while advantageous configurations and developments of the invention can be derived from the dependent claims.

The invention relates to a control operating system of a gas cooking appliance having a control panel with at least an opening for letting through a control shaft of a gas tap arranged behind the control panel, and an operating element made in one piece having a connecting part with a shaft that can be press-fitted in a detachable manner on the control shaft of the gas tap to be actuated and an actuating part with a front area and a skirt extending from the front area towards the control panel around the shaft. The control operating system comprises at least a cap and at least a connecting system between the cap and the operating element in such a manner that the cap is fixedly connectable to the operating element, thereby entirely covering the operating element, so that the control shaft of the gas tap is actuated when the cap is actuated.

The gas cooking appliance may be a gas hob in which the control panel with the operating elements is a part of the horizontal supporting plate where the gas burners are located or the type of a gas stove where the control panel is arranged vertically in front of the appliance. The inside of the gas cooking appliance is delimited by a housing and the supporting plate, which may be made of glass, metal or the like. The gas pipes leading the gas from the collector pipe to the gas tap and from the tap to the gas burner are inside the appliance. And the gas tap is controlled with a shaft extending through the control panel by means of the operating element. The operating element needs to be ergonomic to be held by the user and rotated by applying a force on the shaft of the gas tap. The operating element of the invention is made in one piece of, for example, plastic, zamak or metal. The operating element has a connecting part and an actuating part. With the connecting part, the operating element can be joined to the shaft of the gas tap in a detachable manner by means of a substantially cylindrical hollow shaft having a spring inside the same to exert a coupling force required by the safety rule. The actuating part, which is joined in one piece to the connecting part, is the own body of the operating element, which can be handled by the user and has an overall external shape composed of a front area, when it is observed in the direction of the shaft of the gas tap, and a skirt extending from the front area towards the control panel around the shaft.

In this type of gas cooking appliances, operating elements need to be designed in compliance with the safety rules in force. Therefore, they must be approved following the requirements imposed by the rule. Thus, if it is desired to modify the aesthetical appearance of the appliance by changing the operating elements, the new operating elements need to be approved as well and, for this reason, the cost increases. To reduce the cost of the control operating system of the household appliance, a cap is provided, which can be connected to the operating element by means of a connecting system, the cap remaining thereby fixedly connected to the operating element without any relative movement between them being possible in such a manner that, when the cap is handled, the shaft of the gas tap is directly handled. In this way, no new operating element needing to be approved is required, since the operating element is still the same and only the external shape or the actual connecting part changes. This reduces costs but also provides versatility to the aesthetical change of the appliance, since the cap has a front area of cap when it is observed in the direction of the shaft of the gas tap and a cap skirt surrounding the skirt when the cap is mounted on the operating element.

Furthermore, it is provided that the connecting system is detachable, so that different caps with the operating element can be replaced if needed. The connecting system between the cap and the operating element can be just by a press fit, by a positive connection with a clip connection, by means of a screw joint between the cap and the operating element and/or by means of an additional piece. In a preferred embodiment, at least a part of the connecting system is between the skirt and the cap skirt, preferably the connecting system is between the skirt and the cap skirt. And, in another possible embodiment, at least a part of or the entire connecting system is between the front area and the front area of cap.

So as to facilitate the control of the gas cooking appliance to the user, it is provided that the front area of the operating element has a grabbing area to allow the grabbing of the operating element, while the cap may have or not a grabbing area of cap covering the grabbing area. This is relevant in the case that it is desired to change the aesthetics of the appliance's control in a more or less evident manner. In this case, it is also provided that the connecting system is, at least in part or entirely, between the grabbing area and the grabbing area of cap.

In addition, it is provided that the operating element is made just in one plastic piece, with the connecting and actuating part being injected or shaped in the same process and with the possibility to have an embellishing or functional coating, which can be also applied in the same injection process or later. The functional coating can be autonomously illuminated such as by luminescence or have antibacterial properties or be electrically conductive being adaptable to particular functionalities of the appliance. This is also applicable to the cap. Furthermore, the operating element may have a light guide to lead the light emitted by an external source or by the coating to a particular location of the operating element. The cap may have a passage for light guide, so that light emitted by the operating element can be seen through the passage for light guide in the cap.

In another aspect of the invention, a cap is provided fitting with the operating element of the control operating system of the invention, and another aspect relates to the set of the gas cooking appliance with at least a cap connectable with the operating element or elements of the appliance.

Other advantages derive from the following description of the drawing. An exemplary embodiment of the invention is represented in the drawing. The drawing, the description and the patent claims contain diverse combined features. The person skilled in the art shall also advantageously consider the features separately and gather them in further reasonable combinations.

It is shown in:

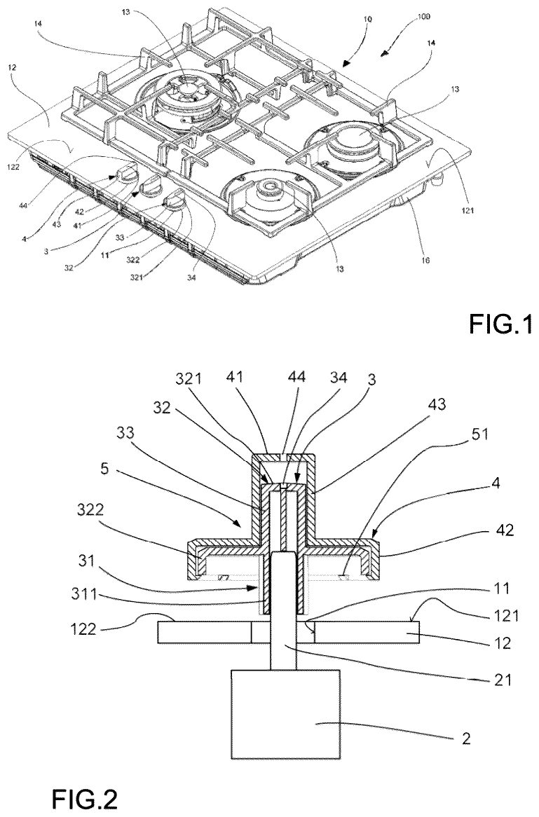

FIG. 1 a perspective of a control operating system of a gas cooking appliance with three operating elements, one of them covered with a cap,

FIG. 2 a section of a detail of the operating element with a cap of the gas cooking appliance from FIG. 1,

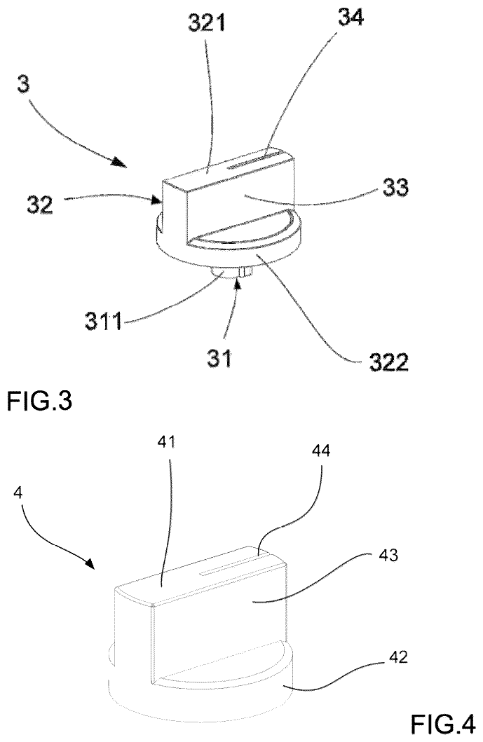

FIG. 3 a perspective view of an operating element, and

FIG. 4 a perspective view of a cap.

A gas cooking appliance 10 like the one from FIG. 1 has an appliance housing 16 and a supporting plate 12 which, in this case, is made of tempered glass but can be made of metal, ceramic material or the like. The supporting plate 12 is rectangular and, in an area close to the perimeter of one of its sides, there is a control panel 122 on which three operating elements 3 are arranged to control gas taps (not visible) controlling the gas and flame flow in the three gas burners 13. The gas burners 13 rest on the top surface 121 of the supporting plate 12. The two supports of cooking vessel 14 also rest detachably on the top surface 121 of the supporting plate 12 and extending over the gas burners 13. In this case, the two supports of cooking vessel 14 cover an almost identical area of the supporting surface but the left one is arranged on a gas burner 13 and the right support of cooking vessel 14 covers two gas burners 13. The supports of cooking vessel 14 can be independent for a gas burner 13 or can cover more than one gas burner 13.

All the gas channellings required to lead the gas from outside the gas cooking appliance 10 through the internal pipes up to the gas burners 13 flowing through the gas taps 2 are inside the gas cooking appliance 10 defined by the supporting plate 12 and the appliance housing 16. Each gas tap 2 has a control shaft 21 extending through a corresponding opening 11 in the control panel 122. The operating elements 3 are press-fitted on each control shaft 21 of each gas tap 2 by means of their connecting part 31 and can be handled by the user since they can be grabbed at their actuating part 32. The actuating part 32 has a front area 321 with a grabbing area 33 and a skirt 322 extending towards the control panel 122 around the connecting part 31 and the shaft 311. There is a light guide 34 through which light can be emitted from the operating element 3 on the top face of the grabbing area 33 of the operating element 3.

On the leftmost operating element 3 of the gas cooking appliance 10, a cap 4 is connected having a front area of cap 41 with a grabbing area of cap 43 and a cap skirt 42 extending towards the control panel 122 around the control shaft 21 of the gas tap 2. On the top face of the grabbing area of cap 43, there is a passage for light guide 44 letting through the illumination emitted by the light guide 34 of the operating element 3 covered by it.

FIG. 2 shows a section of the control panel 122 through the leftmost operating element 3 from FIG. 1. The gas tap 2 is arranged on one side of the control panel 122 inside the gas cooking appliance 10. The gas tap 2 is controlled with a control shaft 21 extending through the control panel 122 through the opening 11. The operating element 3 is connected to the control shaft 21 by means of a shaft 311 part of the connecting part 31.

The connecting part 31 is joined in one piece to the actuating part 32 having a front area 321 with a grabbing area 33 allowing the grabbing of the operating element 3 by the user. The skirt 322 surrounding the shaft 311 of the connecting part 31 extends from the front area 321. On the top face of the front area 321, there is a light guide 34 through which light generated either by a luminescent coating or by an external source of illumination channelling it up to the light guide 34 is emitted.

The cap 4 is connected on the operating element 3 and has a front area of cap 41 with a grabbing area of cap 43 fitted on the front area 321 of the operating element 3. The cap skirt 42 surrounding the skirt 322 of the operating element 3 extends from the front area of cap 41 to the top surface 121 of the control panel 122. Between the operating element 3 and the cap 4, there is a connecting system 5 composed of a press fit between the grabbing area 33 and the grabbing area of cap 43 and a fixation between the cap skirt 42 and the skirt 322 based on tooth-like connecting elements 51 preventing the cap 4 from moving out of its position on the operating element 3. On the top face of the front area of cap 41, there is passage for light guide 44 through which light generated either by the luminescent coating or by the external source of illumination emitted by the light guide 34 of the operating element 3 flows.

FIG. 3 shows in a perspective view an operating element 3 made in one plastic piece having a connecting part 31 with a shaft 311 and an actuating part 32 with a front area 321 in which there is a grabbing area 33 and a skirt 322 extending around the shaft 311 of the connecting part 31. On the top face of the grabbing area 33 of the operating element 3, there is a light guide 34 through which light generated either by a luminescent coating on the surface of the light guide 34 or by an external source of illumination channelling up to the light guide 34 is emitted.

FIG. 4 shows in a perspective view the cap 4 made in one plastic piece having a front area of cap 41 in which there is a grabbing area of cap 43 and a cap skirt 42. On the top face of the grabbing area of cap 43, there is a passage for light guide 44 through which light generated in the operating element 3 when the cap 4 is connected to the same can flow.

### REFERENCE NUMERALS

10 gas cooking appliance
11 opening
12 supporting plate
121 top surface
122 control panel
13 gas burner
14 support of cooking vessel
16 appliance housing
2 gas tap
21 control shaft
3 operating element
31 connecting part
311 shaft
32 actuating part
321 front area
322 skirt
33 grabbing area
34 light guide
4 cap
41 front area of cap
42 cap skirt
43 grabbing area of cap
44 passage for light guide
5 connecting system
51 connecting element
100 control operating system

1-14. (canceled)

15. A control operating system of a gas cooking appliance, the control operating system comprising:
a control panel including an opening for letting through a control shaft of a gas tap arranged behind the control panel;
an operating element made in one piece and comprising a connecting part which includes a shaft designed to be press-fitted in a detachable manner on the control shaft of the gas tap to be actuated, and an actuating part including a front area and a skirt extending from the front area towards the control panel around the shaft;
a cap; and
a connecting system arranged between the cap and the operating element in such a manner that the cap is fixedly connectable to the operating element, thereby entirely covering the operating element, so that the control shaft of the gas tap is actuated when the cap is actuated.

16. The control operating system of claim 15, wherein the cap includes a front area of cap and a cap skirt surrounding the skirt of the actuating part when the cap is mounted on the operating element.

17. The control operating system of claim 15, wherein the connecting system is detachable.

18. The control operating system of claim 15, wherein the connecting system is designed to press-fit the cap on the operating element.

19. The control operating system of claim 15, wherein the connecting system includes a clip element designed to connect the cap by a positive connection to the operating element.

20. The control operating system of claim 15, wherein the connecting system includes a screw joint designed to connect the cap to the operating element.

21. The control operating system of claim 16, wherein at least a part of the connecting system is between the skirt of the actuating part and the cap skirt.

22. The control operating system of claim 16, wherein at least a part of the connecting system is between the front area of the actuating part and the front area of cap.

23. The control operating system of claim 15, wherein the front area of the actuating part includes a grabbing area designed to allow grabbing of the operating element, said cap including a grabbing area of cap designed to cover the grabbing area of the actuating part.

24. The control operating system of claim 23, wherein the connecting system is arranged between the grabbing area of the actuating part and the grabbing area of cap.

25. The control operating system of claim 15, wherein the operating element is made of plastic.

26. The control operating system of claim 15, further comprising an embellishing coating applied on the operating element and/or a light guide provided in the operating element.

27. The control operating system of claim 15, wherein the cap includes a passage for light guide.

28. A cap for the control operating system of claim 15, the cap comprising a front area of cap and a cap skirt surrounding the skirt of the actuating part when the cap is mounted on the operating element.

29. The cap of claim 28, wherein the cap includes a grabbing area of cap designed to cover a grabbing area of the actuating part.

30. A set, comprising:
a gas cooking appliance comprising a control operating system including a control panel, and a gas tap arranged behind the control panel and including a control shaft extending through an opening of the control panel, the control operating system further comprising an operating element made in one piece and comprising a connecting part which includes a shaft designed to be press-fitted in a detachable manner on the control shaft of the gas tap to be actuated, and an actuating part including a front area and a skirt extending from the front area towards the control panel around the shaft; and
a cap comprising a front area of cap and a cap skirt surrounding the skirt of the actuating part when the cap is mounted on the operating element,
wherein the control operating system comprises a connecting system arranged between the cap and the operating element in such a manner that the cap is fixedly connectable to the operating element, thereby entirely covering the operating element, so that the control shaft of the gas tap is actuated when the cap is actuated.
